(19) United States
(12) Patent Application Publication
(10) Pub. No.: US 2002/0041707 A1
(43) Pub. Date: Apr. 11, 2002

(54) Real-time color correction of digitally recorded video

(76) Inventor: David A. Newman, San Diego, CA (US)

Correspondence Address: Pillsbury Winthrop LLP, Intellectual Property Group, 50 Fremont Street, San Francisco, CA, 94105-2228, US

(21) Appl. No.: 09/827,376

(22) Filed: Apr. 5, 2001

Related U.S. Application Data
(60) Provisional application No. 60/195,666, filed on Apr. 7, 2000.

(51) Int. Cl. G06K 9/00

(52) U.S. Cl. 382/167

(57) ABSTRACT

A non-linear video editing apparatus and method, the apparatus comprising a data processor, a storage device capable of storing a plurality of digital video frames, a color correction program executed by the data processor. Each frame comprises a plurality of YUV color space pixels. The color correction program receives data indicative of a color correction and color corrects substantially all of the pixels in the digital video frames by adjusting Y, U and V gamma tables according to the received data.

### RELATED APPLICATIONS

This patent application incorporates by reference the following U.S. patent applications:

| Atty | | | |
|---|---|---|---|
| Docket No. | Filing Date | App. No. | Title |
| APMAGIC.001A | 08/05/97 | 08/906,589 | NON-LINEAR |
| | | | EDITING SYSTEM |
| | | | FOR HOME |
| | | | ENTERTAINMENT |
| | | | ENVIRONMENTS |
| APMAGJC.007A | 08/05/97 | 08/906,304 | MEDIA EDITOR |
| | | | FOR NON-LINEAR |
| | | | EDITING SYSTEM |
| APMAGIC.026PR | 06/21/99 | 60/140,474 | POINT AND CLICK |
| | | | WHITE BALANCING |
| | | | OF DIGITAL |
| | | | RECORDED VIDEO |

### PROBLEM BEING SOLVED

The typical video editing system enables the user to adjust red, green blue (R,G,B) sliders while viewing a single frame of video. By adjusting the sliders, the user can manually tune the video frame to the appropriate color settings, but the change only effects the existing frame of video. In order to implement the change to the entire video sequence, the user must then rely upon the computer to render in the change across that sequence using the system's microprocessor. A typical render time would be approximately 30 times real time—meaning that a 20-second sequence would take 600 seconds, or 10 minutes to render. Additional problems are inherent with computer-based editing systems. Adjusting to the appropriate color is very difficult since the user is looking at a computer monitor which displays video in a different color space from a television—the ultimate visual display.

The present invention overcomes both of these problems, and is embodied as the first editing system to incorporate and perform color correction in real-time across the video sequence. In order to do this, one embodiment of the invention incorporates a hardware gamma table which the video is played through, and which can be tuned differently for each video clip within a sequence of video clips (video project). Other systems incorporate gamma tables into the system's encoder, but they can only be set once upon playback of the entire video project. Since different clips within a project are shot under different conditions, one gamma setting could not possibly accommodate (color correct) all video clips within a project. The invention's unique approach enables each video clip to undergo unique gamma correction on the fly.

### SUMMARY

In one aspect of the present invention, there is a non-linear video editing device, comprising a data processor, a storage device capable of storing a plurality of digital video frames, wherein each frame comprises a plurality of YUV color space pixels, a color correction program executed by the data processor, wherein the color correction program receives data indicative of a color correction and color corrects substantially all of the pixels in the digital video frames by adjusting Y, U and V gamma tables according to the received data. This device also includes a method wherein the plurality of digital video frames are in a sequential order and comprise a video clip. This device also includes a method wherein each of the Y, U and V gamma tables are stored in a memory. This device also includes a method wherein the data processor transfers gamma data indicative of the color correction into each of the Y, U and V gamma table memories. This device also includes a method wherein the color correction comprises quantities associated with a combination of the following: brightness, contrast, saturation, red, green, and blue. This device also includes a method wherein the color correction program includes a conversion module configured to convert color correction quantities to Y, U, and V gamma tables. This device also includes a method wherein the color correction of substantially all of the pixels in the digital video frames is performed in real-time.

### DESCRIPTION OF CERTAIN EMBODIMENTS OF THE INVENTION

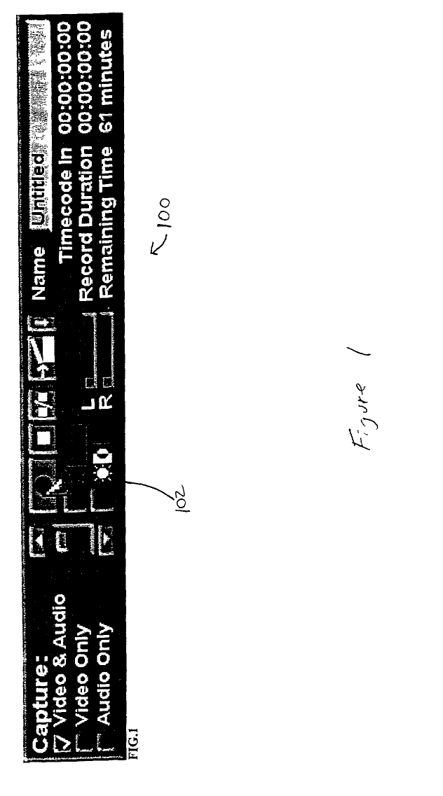

One embodiment of the invention will now be described with reference to the attached Figures. FIGS. 1-13 are a sequence of screen displays associated with one user interface embodiment. Of course, the invention encompasses a multitude of implementations which allow input of color correction information.

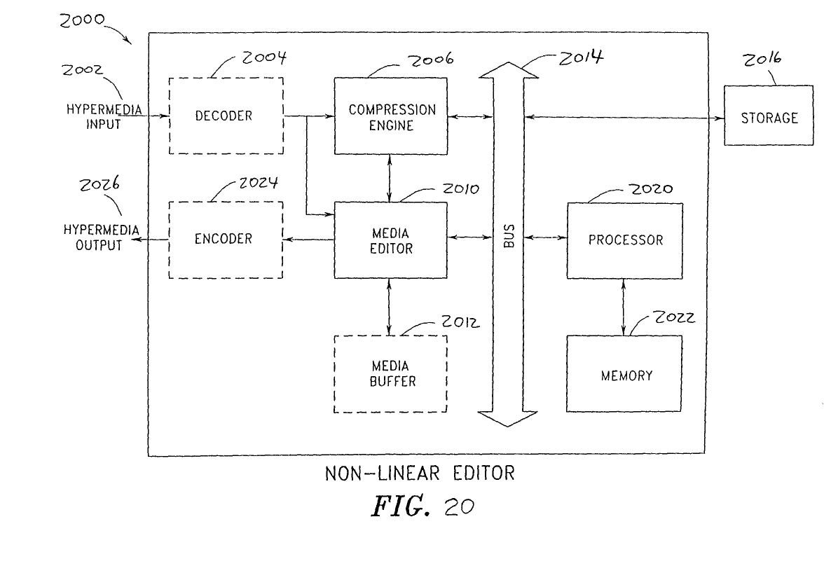

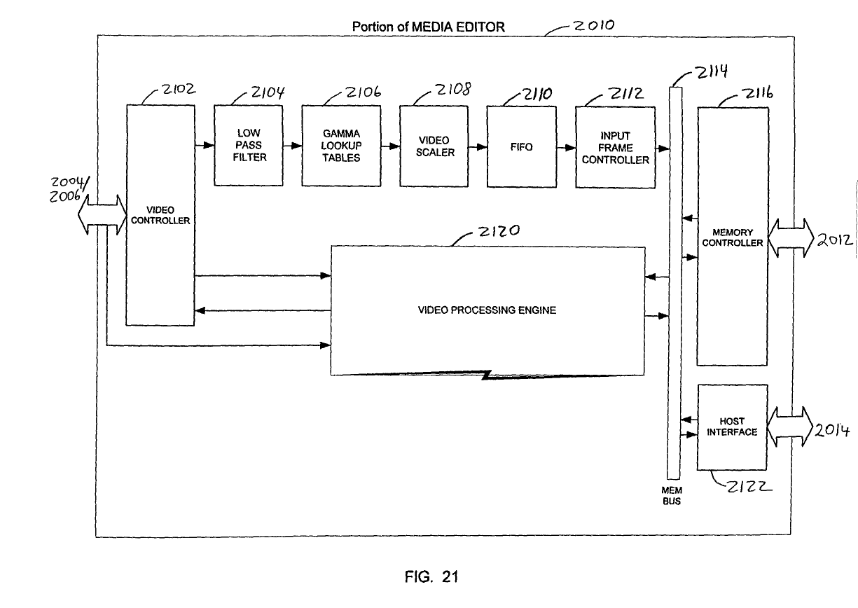

Referring to FIG. 1, in order to use the color correction feature of the video editing system, a user is first presented with a capture screen 100 to digitally capture video onto a storage device, e.g., storage 2016 (FIG. 20), such as a hard disk drive.

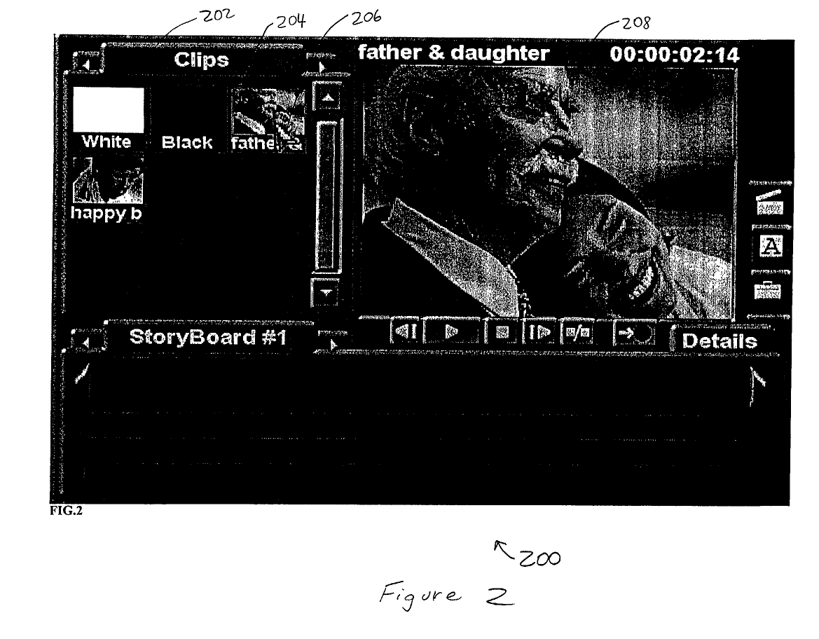

Referring to FIG. 2, the user would return to the editor screen 200, where the newly captured video 204 would appear in the clips bin 202. If the user selects the video clip using the on-screen cursor 206, the clip may appear with a highlight around it.

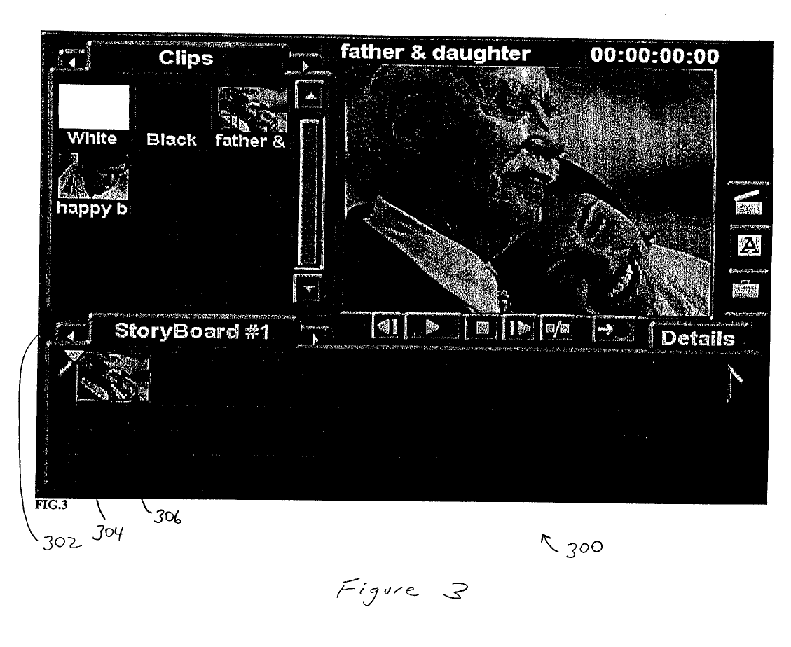

Referring to FIG. 3, the user may now place this video clip within a video project by dragging and dropping the clip 304 onto the storyboard 302 within the editor screen 300.

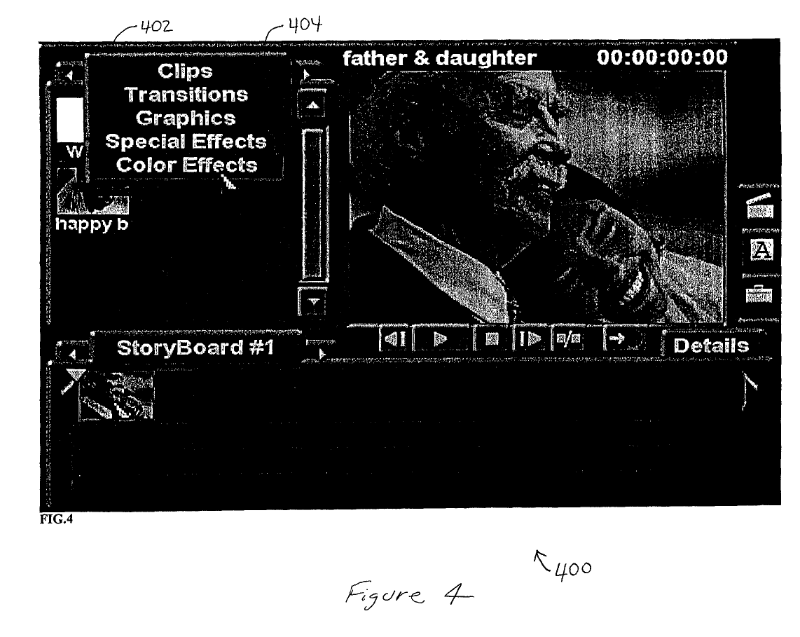

Referring to FIG. 4, the user can choose to apply a color effect to the video clip. To do so, the user navigates to the color effects bin by selecting a pull-down menu above the bin 402 and selecting the color effects option 404.

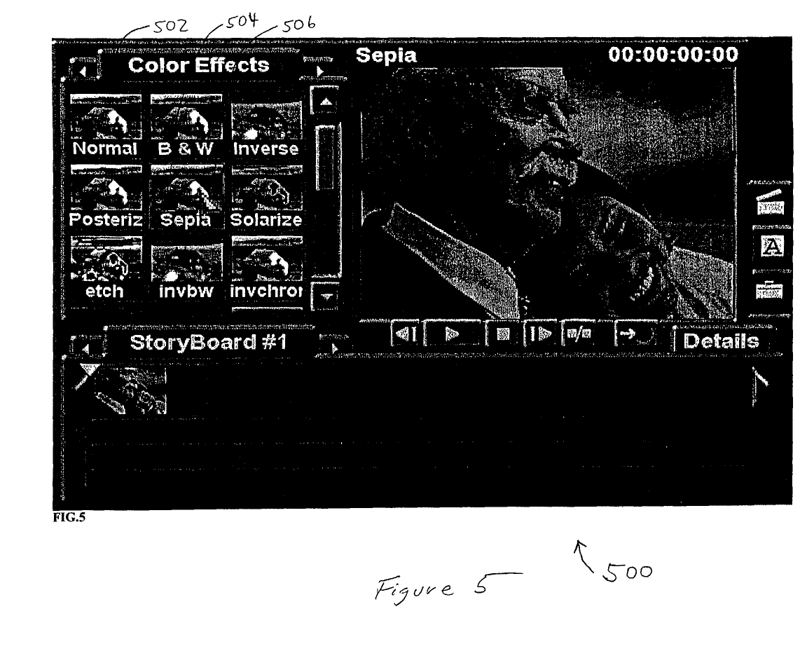

Referring to FIG. 5, when the color effects bin appears on-screen at element 502, the user can select a color effect which he would like to apply to the video clip. The selected color effect will appear with a highlight around it at element 504.

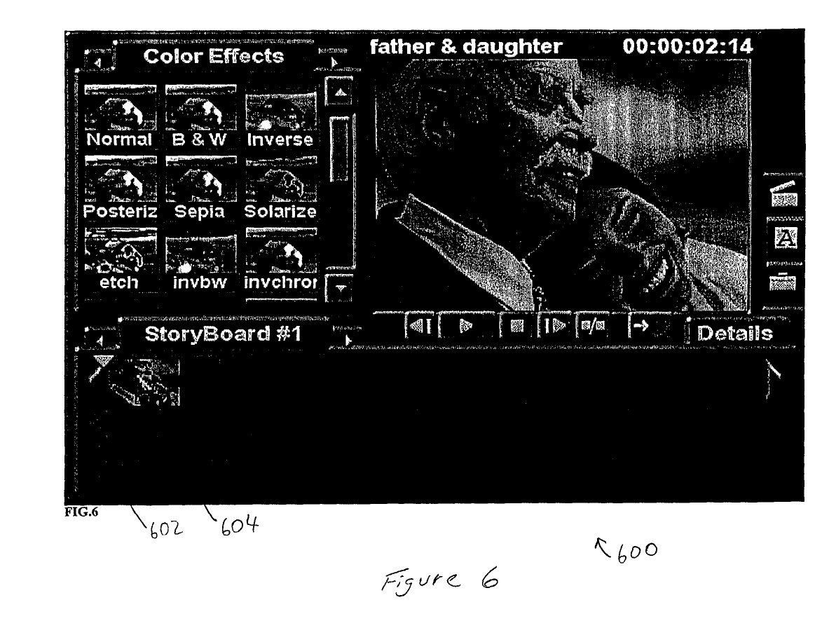

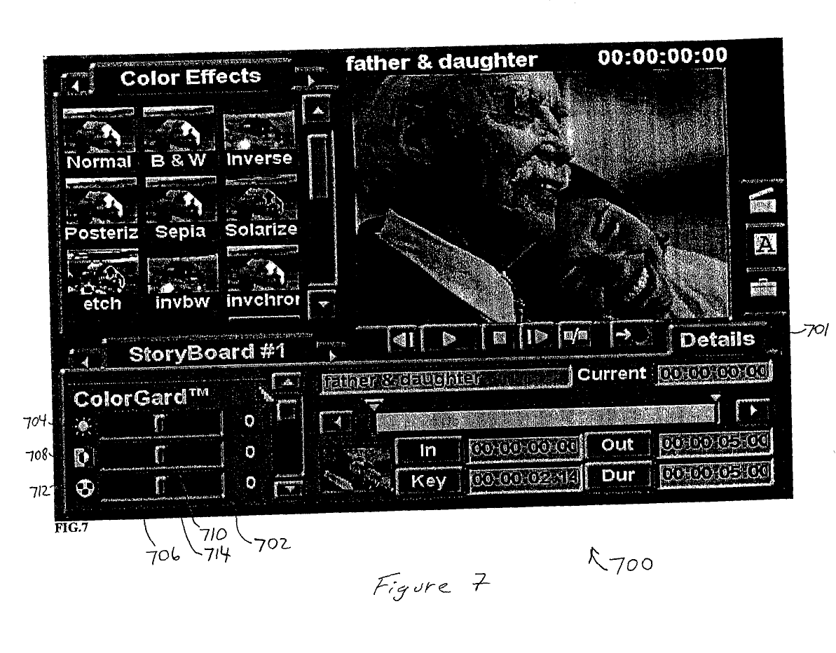

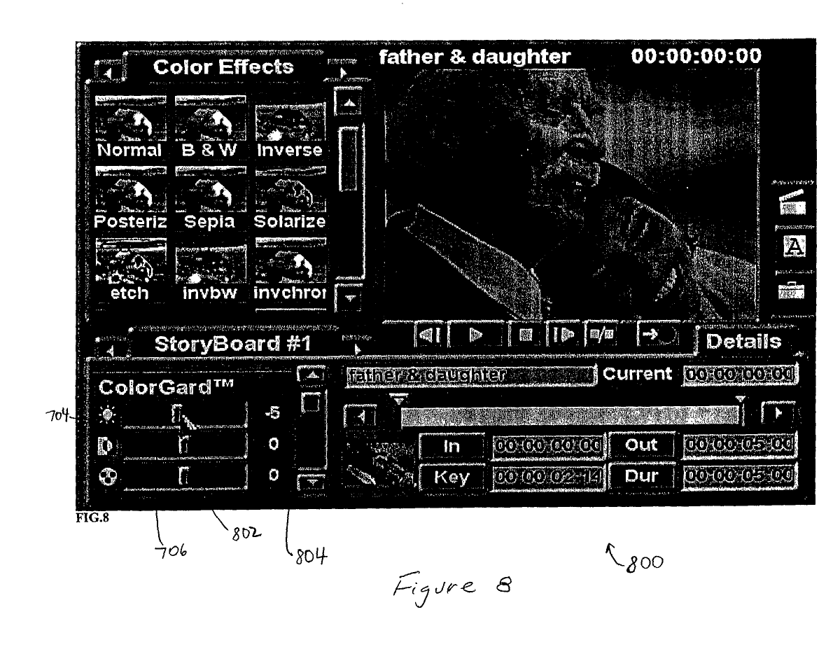

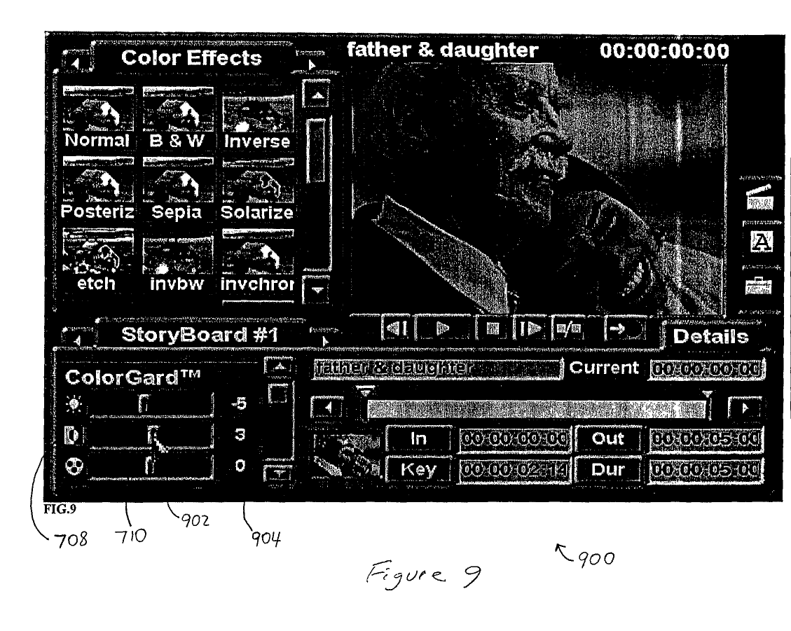

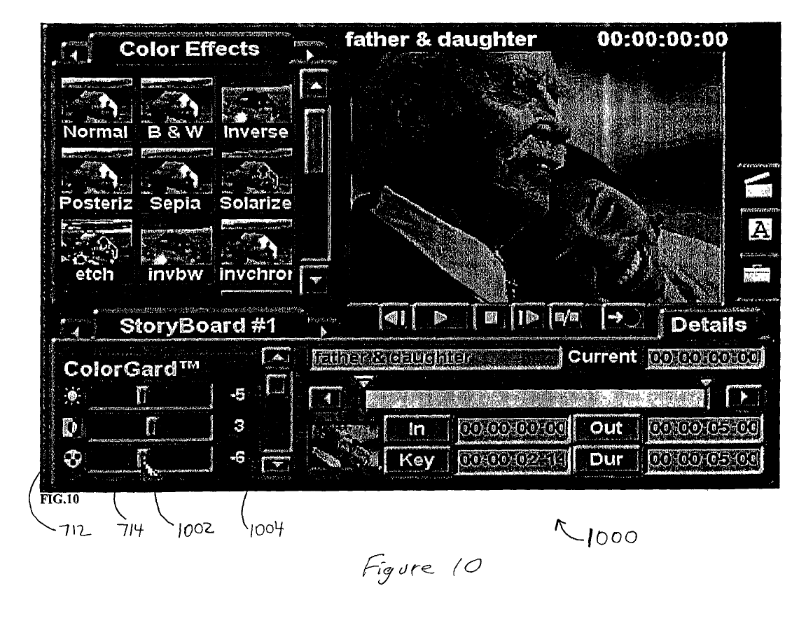

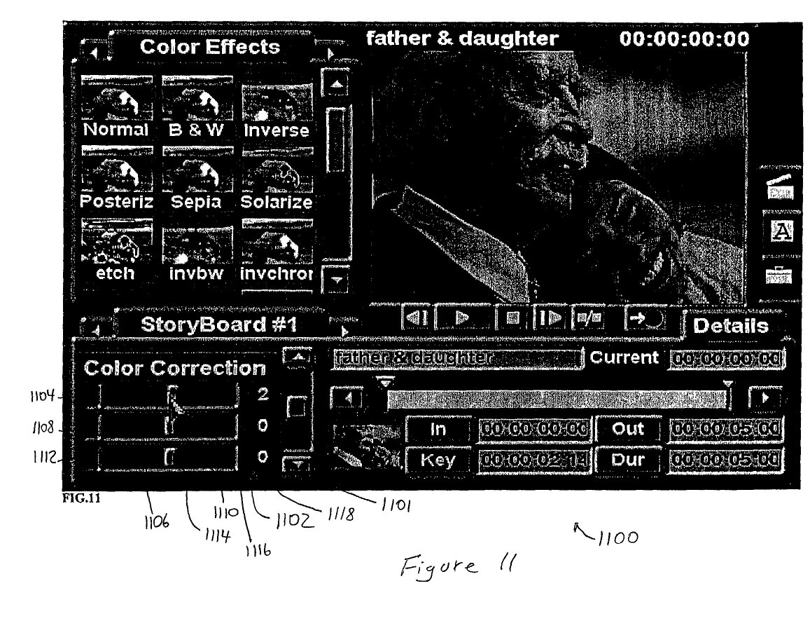

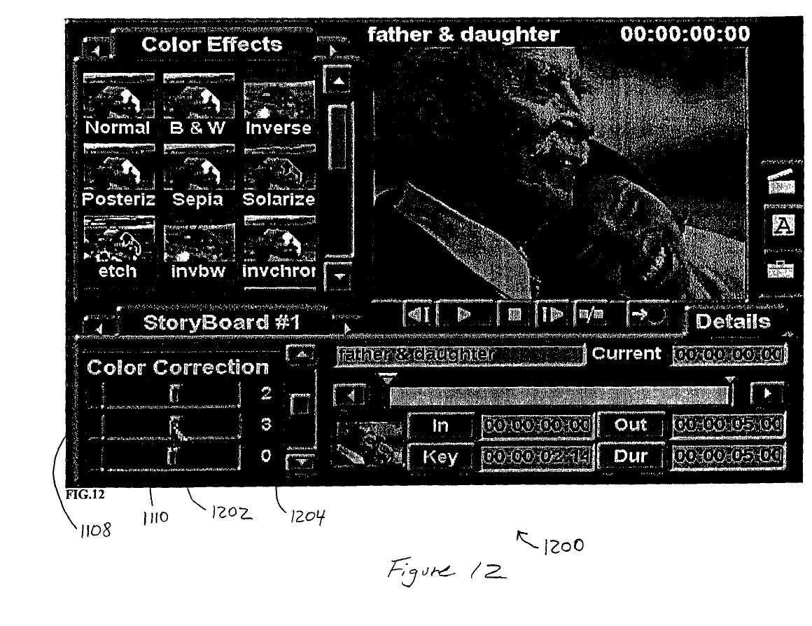

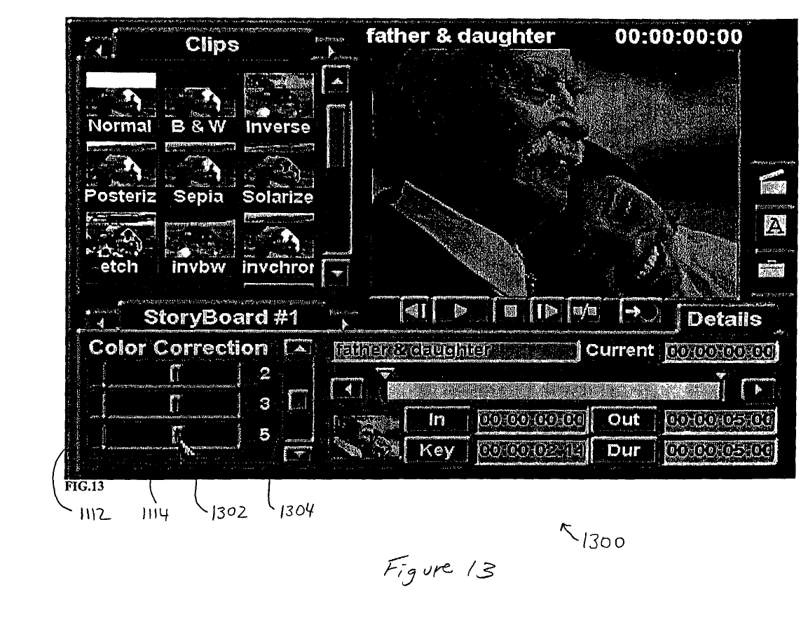

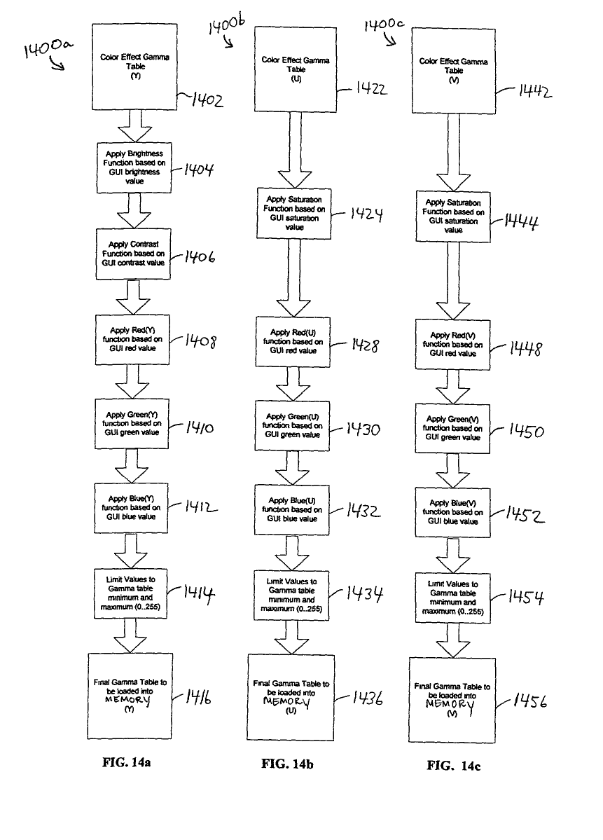

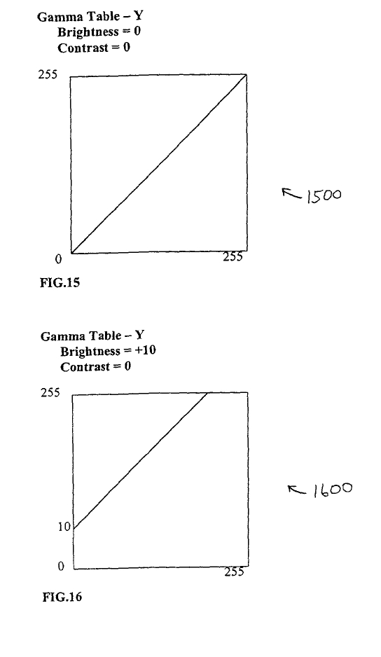

Referring to FIG. 6, the user can then drag and drop the color effect onto the video clip 602.

Referring to FIG. 7, the user will enter the details window to further modify the color settings of his video clip. To access the details window, the user must use the on-screen cursor to click on the details tab 701. The details window will then appear on the bottom portion of the screen 700. Within the visible area of the details tab will be the brightness 704, contrast 708, and saturation 712 settings.

Referring to FIG. 8, the user may adjust the brightness setting 704 by moving the an on-screen slider 706 to the left (indicating decreased brightness) or right (indicating increased brightness).

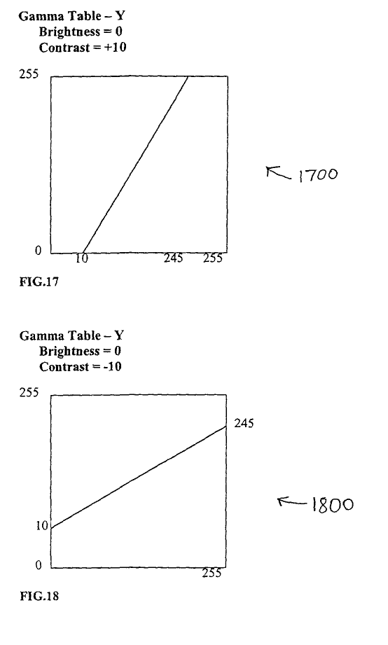

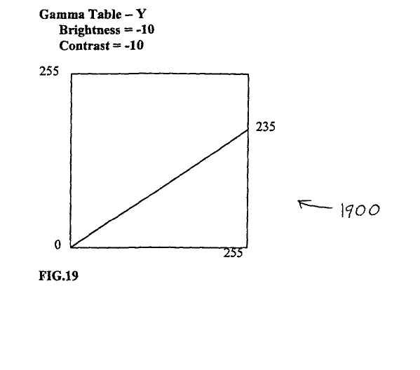

Referring to FIGS. 9 and 10, the contrast 708 and saturation 712 settings can also be modified by moving these on-screen sliders 710, 714.

Referring to FIG. 11, to access the red, green and blue color adjustments (color correctio within the details window, the user must move the vertical slider bar 104 until these items become visible.

Referring to FIGS. 11, 12 and 13, to adjust the red 1104, green 1108 and blue 1112 settings, the user again moves one or more of a set of horizontal sliders 1106, 1110, 1114 left to indicate decreased color, right to indicate increase color.

FIG. 14 is a flowchart for software which may be executed by a data processor to convert color correction information into Y, U, V gamma tables. The video editing system adjusts the color of a video clip by first accessing the YUV gamma tables for the color effect applied to the video clip at states 1402, 1422, 1442 (in the case of a video clip with no color effect attached, this would be the “normal” gamma table).

As the user applies new brightness at state 1404 as in FIG. 8, contrast as in FIG. 9 at state 1406, and saturation as in FIG. 10, at states 1444, 1424, the values within the gamma tables are modified accordingly.

As the user applies new red as in FIG. 11 at states 1408, 1428, 1448, green as in FIG. 12 at states 1410, 1430, 1450 and blue as in FIG. 13 at states 1412, 1432, 1452 settings, the values within the gamma tables are modified accordingly.

In one embodiment, the new values within the YUV gamma tables are then limited to between the minimum and maximum values of 0 and 255 at states 1414, 1434, 1454.

In one embodiment, the final gamma tables are then loaded into the media editor 2010 (see FIGS. 20 and 21) at states 1416, 1436, 1456.

Referring to FIG. 15, an exemplary Y gamma table with a brightness value of 0 and a contrast value of 0 will form the line shown in the plot 1500.

Referring to FIG. 16, an exemplary Y gamma table with a brightness value of +10 and a contrast value of 0 will form the line shown in the plot 1600. Referring to FIG. 17, an exemplary Y gamma table with a brightness value of 0 and a contrast value of +10 will form the line shown in the plot 1700.

Referring to FIG. 18, an exemplary Y gamma table with a brightness value of 0 and a contrast value of −10 will form the line shown in the plot 1800.

Referring to FIG. 19, an exemplary Y gamma table with a brightness value of −10 and a contrast value of −10 will form the line shown in the plot 1900.

Referring to FIG. 20, in one embodiment, a video editor architecture is shown to implement the low level aspects of the gamma tables, after generation by the algorithms shown in FIG. 14.

FIG. 21 is a detailed view of the media editor 2010 shown in FIG. 20. Block 2106 indicates the location of the Gamma Lookup Tables. In one embodiment, the Gamma Lookup Tables comprise three memories, which, in one embodiment are 256×8 bits. The GLT may also include an input and/or output register for buffering the data transferred in and out of the memories. The user interface is one way to input color correction information which is algorithmically translated to Y, U, V gamma tables. The new tables are transferred from the host interface 2122 through the blocks 2120, 2102 and 2104, before being stored in block 2106 of the media editor 2010.

Certain Features and Advantages

a. Color can be corrected in real-time

b. Color adjustments made to one frame carry across an entire video clip in real-time

c. Color adjustments can be made with a visual display device such as a television set (the final video destination)

We claim:

1. A method of editing digital video frames wherein each frame comprises a plurality of YUV color-space pixels, comprising:
receiving data indicative of a color correction;
adjusting Y, U, and V gamma tables according to the received data.
